(19) United States
(12) Patent Application Publication
(10) Pub. No.: US 2025/0148812 A1
(43) Pub. Date: May 8, 2025

(54) SYSTEM AND METHOD FOR COOKING APPLIANCE OPERATION USING FOOD WEIGHT ESTIMATION

(71) Applicant: Haier US Appliance Solutions, Inc., Wilmington, DE (US)

(72) Inventors: Hyeonsoo Moon, Seoul (KR); Kunwoo Kim, Seoul (KR); JaeHyo Lee, Seoul (KR)

(21) Appl. No.: 18/500,535

(22) Filed: Nov. 2, 2023

(51) Int. Cl. G06V 20/68; A23L 5/10; A47J 36/32; G06V 10/22; G06V 10/25; G06V 10/26; G06V 20/50

(52) U.S. Cl. CPC G06V 20/68; A23L 5/10; A47J 36/32; G06V 10/225; G06V 10/25; G06V 10/26; G06V 20/50

(57) ABSTRACT

A cooking appliance and method for operation are provided. The cooking appliance is configured to obtain an image at a cooking region; determine, via a first detection model, a bounding of one or more types of objects within the image; set, at a second detection model, a region of interest at the image including the objects; determine, via the second detection model, a quantity of segmented pixels for each type of object within the image; determine a weight of each type of object based on the quantity of segmented pixels corresponding to each type of object within the image; correspond the weight of each type of object in the image to a cooking program; and operate the cooking appliance based on the cooking program.

### FIELD

The present subject matter relates generally to cooking appliances and methods for determining cooking parameters at the cooking appliance.

### BACKGROUND

Cooking appliances, such as conventional and microwave ovens, air fryers, and other cooking appliances, may include controls with predetermined cooking programs. Users generally desire appliances that can automatically recommend cook time, temperature, or power settings for cooking food. However, predetermined cooking programs may fail to accurately account for various food sizes or portions, or different input temperatures (e.g., frozen food, partially defrosted food, room temperature food, etc.).

Cooking control methods including artificial intelligence may be limited by the availability of data. For instance, a limit of datasets of various food, food types, or the quality of the data may prevent utilizing artificial intelligence for cooking programs.

Accordingly, a system and method for cooking appliance operation with improved cooking program is desired and would be advantageous. Additionally, systems and methods for determining type of food at a cooking appliance for a cooking program would be desired and advantageous.

### BRIEF DESCRIPTION

Aspects and advantages of the invention will be set forth in part in the following description, or may be obvious from the description, or may be learned through practice of the invention.

An aspect of the present disclosure is directed to a cooking appliance including an imaging device configured to obtain an image at a cooking region of the cooking appliance. A controller is configured to store instructions that, when executed, causes the cooking appliance to perform operations. The operations include obtaining, via the imaging device, an image at the cooking region; determining, via a first detection model, a bounding of one or more types of objects within the image; setting, at a second detection model, a region of interest at the image including the objects; determining, via the second detection model, a quantity of segmented pixels for each type of object within the image; determining a weight of each type of object based on the quantity of segmented pixels corresponding to each type of object within the image; corresponding the weight of each type of object in the image to a cooking program; and operating the cooking appliance based on the cooking program.

Another aspect of the present disclosure is directed to a method for operating a cooking appliance, the method including obtaining, via the imaging device, an image at the cooking region; determining, via a first detection model, a bounding of one or more types of objects within the image; setting, at a second detection model, a region of interest at the image including the objects; determining, via the second detection model, a quantity of segmented pixels for each type of object within the image; determining a weight of each type of object based on the quantity of segmented pixels corresponding to each type of object within the image; corresponding the weight of each type of object in the image to a cooking program; and operating the cooking appliance based on the cooking program.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 depicts an embodiment of a cooking appliance configured to execute steps of a method for cooking appliance operation in accordance with aspects of the present disclosure;

FIG. 2 provides a schematic embodiment of a system for cooking appliance operation in accordance with aspects of the present disclosure;

FIG. 3 provides a flowchart outlining steps of a method for cooking appliance operation in accordance with aspects of the present disclosure;

FIG. 4 provides an exemplary depiction of a pe-pixel map in accordance with aspects of the present disclosure;

FIG. 5 depicts an exemplary cooking region and operation of an embodiment of the method in accordance with aspects of the present disclosure; and

FIG. 6 depicts an exemplary cooking region and operation of an embodiment of the method in accordance with aspects of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

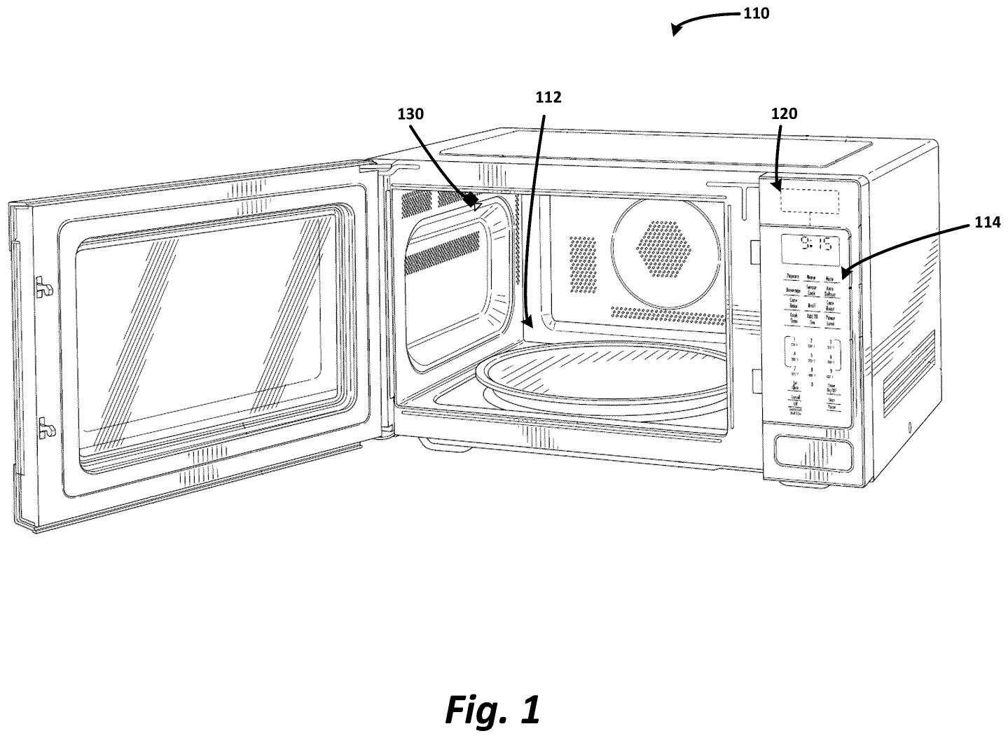

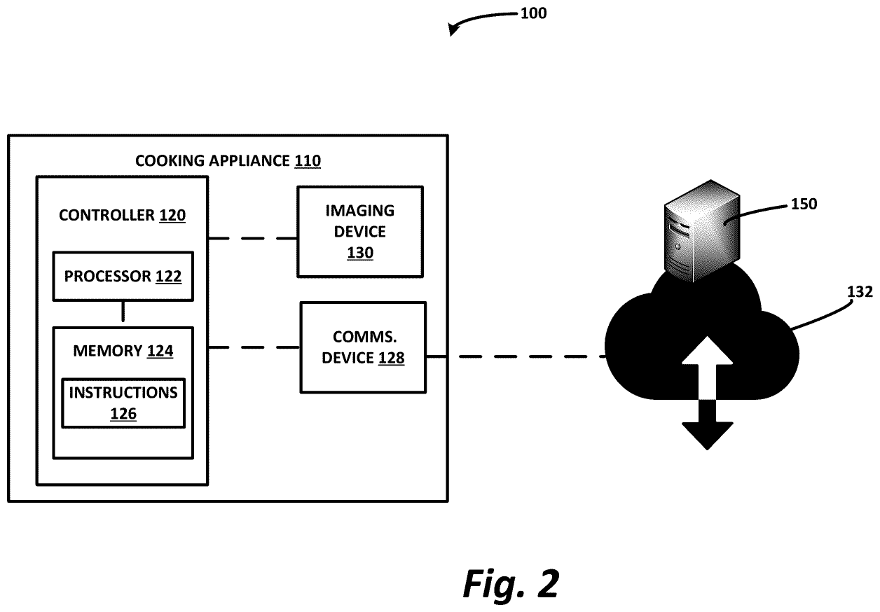

Referring now to the drawings, FIGS. 1-2 depict embodiments of a system 100 and method 1000 for cooking appliance operation that may provide an improved cooking program that addresses one or more of the aforementioned issues is described herein. Embodiments of the system 100 include a cooking appliance 110, such as, but not limited to, a microwave oven appliance, a conventional and/or convection oven appliance, a stove top or burner appliance, or an air fryer appliance. The system 100 includes a controller 120 including one or more processing devices 122 and memory devices 124 configured to store instructions 126, such as steps of the method 1000, that, when executed, causes the cooking appliance 110 to perform operations, such as described further herein. Steps of method 1000 may form steps of a computer-implemented method, such as via a controller (e.g., controller 120), for operating a cooking appliance. The controller 120 is operably coupled to an imaging device 130 configured to obtain images of objects, such as food, positioned at a cooking region, such as region 112 depicted schematically at FIG. 1. In various embodiments, the cooking region 112 may include, but is not limited to, a cooking chamber within a microwave, conventional, or convection oven appliance, a cooking surface at a stove-top or griddle, or a utensil (e.g., pot, pan, skillet, etc.) positioned at a heating element or cooking surface, or a plate, saucer, bowl, or the like positioned at the cooking chamber or cooking surface.

The cooking appliance 110 may include a user interface panel 114 for receiving user inputs, providing prompts to the user, communicating messages to the user, and the like. The user interface panel 114 may include a touchscreen, a keyboard, or other appropriate device(s) for receiving, displaying, or providing visual and/or auditory messages.

Various embodiments of the system 100 may include a communications device 128. The communications device 128 may be configured to access a network 132, such as a local area network or the internet, or access an internet-connectable device, such as, but not limited to, a remote computing device (e.g., a smartphone, a tablet, an internet accessible appliance, etc.) or server 150. Embodiments of the system 100 and method 1000 further described herein may include steps, instructions, or operations performed locally at the controller 120, or performed, at least in part, through a remote computing device, a server, or other network-accessible computing device. Still some embodiments of the system 100 and method 1000 may be configured to perform all, or substantially all, of the steps, instructions, or operations via the controller 120 at the cooking appliance 110.

Embodiments of the system 100 and method 1000 overcome issues with predetermined time and/or temperature settings for cooking food at a cooking appliance. For instance, known cooking programs generally provide cooking time and/or temperature based on a food type (e.g., popcorn, meat, vegetables, etc.). However, such cooking programs generally fail to account for quantity or amount of the food type. Still further, such cooking programs may generally fail to consider mixtures of food types (e.g., meat and vegetables, poultry and starch, vegetables and starch, etc.).

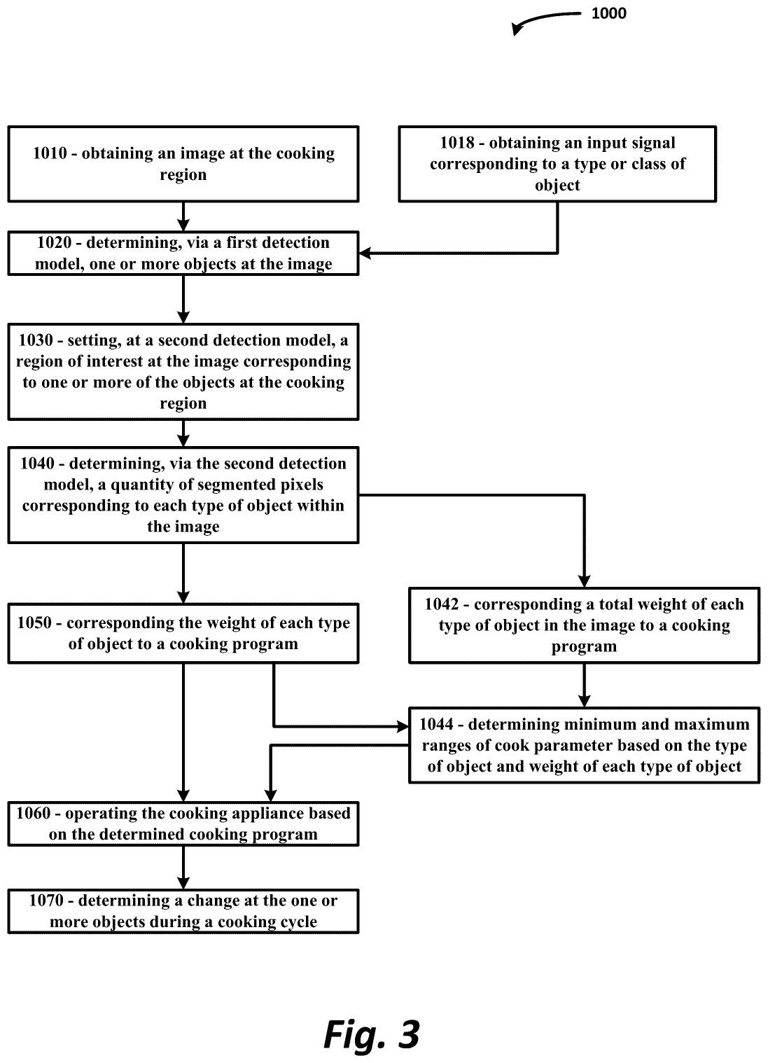

Referring to FIG. 3, a flowchart outlining exemplary steps of the method 1000 is provided. It should be appreciated that steps of method 1000 may form, at least in a part, instructions 126 executable by controller 120 of embodiments of the cooking appliance 110. However, it should be appreciated that method 1000 may be stored at any appropriate controller or computing device, or distributed across a plurality of computing devices, or stored as instructions in a cloud computing device (e.g., network 132 and server 150). Method 1000, or portions thereof, may be executed at any appropriate cooking appliance.

Embodiments of the system 100 and method 1000 may overcome the aforementioned issues via a method for cooking appliance using food weight estimation. Embodiments of the method 1000 include at 1010 obtaining or capturing an image at the cooking region, such as via imaging device 130 positioned with a field of view corresponding to cooking region 112.

Method 1000 includes at 1020 determining, via an object detection model (e.g., a first detection model), one or more objects at the image. The object detection model is configured to receive an input signal corresponding to a type or class of object. Method 1000 at 1020 generates a bounding of one or more types of objects within the image.

The input signal may include a human language input, such as selection by the user from a list, or a free-form text input from the user. In some embodiments, method 1000 includes at 1018 obtaining an input signal corresponding to a type or class of object, and at 1020 the object detection model determines or detects one or more objects at the image corresponding to the input signal.

For instance, the input signal may correspond to a user input of “vegetables”, “meat”, “poultry”, “fish”, “starch”, “soup”, “bread”, or other types or classes of food. The user input may be obtained from selection from a list (e.g., a menu) of predefined types or classes, or from an open field prompt at which the user provides the user input. In still various embodiments, the user input may correspond to a sub-type of a type or class of food, such as, e.g., zucchini, asparagus, or cauliflower under vegetables, beef or lamb under meat, chicken or turkey under poultry, etc.

Still for instance, method 1000 may include obtaining a plurality of input signals corresponding to a plurality of types or classes of objects, and determining the corresponding objects at the image.

In still various embodiments, method 1000 may include an automatic detection routine, such as determining the one or more objects at the image based on a predefined set of objects or type of objects, such as, but not limited to, “vegetables”, “meat”, “poultry”, “fish”, “starch”, “soup”, “bread”, or other types or classes of food, or subsets thereof. Embodiments of the method 1000 at 1018 may include transmitting an input signal corresponding to a determined type or class of food based on the predefined set of objects or type of objects. As such, a manual user input may be obviated, and embodiments of the method 1000 may allow for automatic determination of cooking program, or furthermore, automatic adjustments to the cooking program.

Embodiments of the method 1000 include at 1030 setting, at a segmentation model (e.g., a second detection model), a region of interest at the image corresponding to one or more of the objects at the cooking region. Setting the region of interest may correspond to determining the one or more objects at the image, such that bounding boxes generated by the object detection model form regions of interest at the image corresponding to objects at the cooking region.

Method 1000 includes at 1040 determining, via the segmentation model, a quantity of segmented pixels corresponding to each type of object within the image.

For instance, method 1000 at 1020 may determine may detect and generate bounding boxes corresponding to a first object type (e.g., a vegetable), a second object type (e.g., a meat), a third object type (e.g., a starch), etc., to an Nth object type. In still another instance, method 1000 at 1020 may determine object types in further detail (e.g., sub-types), such as a first object type (e.g., zucchini), a second object type (e.g., asparagus), a third object type (e.g., cauliflower), etc.

Using the determined object types, method 1000 at 1030 sets regions of interest corresponding to the determined object types. Method 1000 at 1040 determines a quantity of pixels corresponding to the first object type, the second object type, the third object type, etc., to an Nth object type.

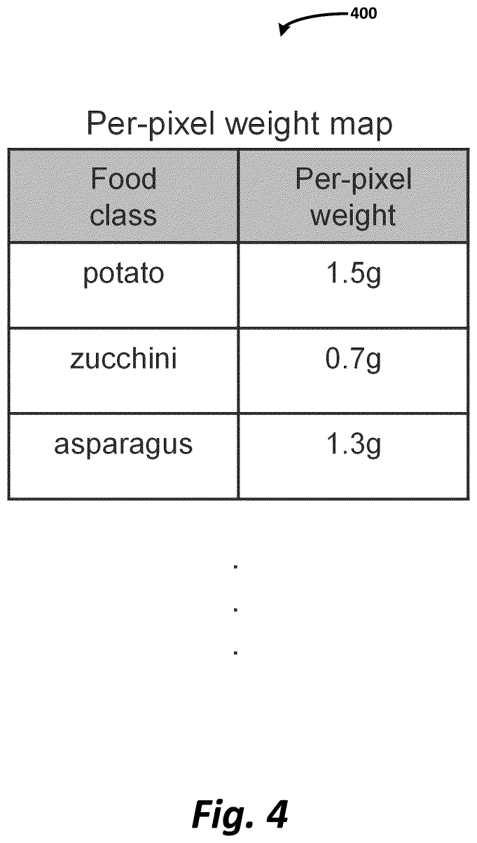

Method 1000 includes at 1040 determining a weight of each type of object based on the quantity of segmented pixels corresponding to each type of object within the image. Method 1000 at 1040 may include comparing the quantity of segmented pixels to a map, table, chart, graph, curve, function, or database of per-pixel weights corresponding to each type of object, such as provided in the exemplary depiction at table 400 at FIG. 4.

Method 1000 may include at 1050 corresponding the weight of each type of object to a cooking program, such as a cook time, a power or heat output, or combinations thereof, or changes therein (e.g., a first power output for a first period of time, a second power output for a second period of time, etc., an Nth power output for an Nth period of time).

In some embodiments, method 1000 includes at 1042 corresponding a total weight of each type of object in the image to a cooking program.

In still some embodiments, method 1000 includes at 1044 determining minimum and maximum ranges of cook parameter, such as, but not limited to, cook time, power output, etc., based on the type(s) of object and weight of each type of object. For instance, a first cook program may correspond to a first type of object based on a first object weight, and a second cook program may correspond to a second type of object based on a second object weight, etc. Method 1000 at 1044 may determine a cook program, or average of a plurality of cook programs, appropriate for heating the plurality of objects. In still various embodiments, method 1000 at 1044 may determine the cook program appropriate for heating the plurality of objects without overheating one or more of the objects. As such, method 1000 at 1044 may determine a minimum time, power, etc. based on heating all of the object types at the cooking region, and determine a maximum time, power, etc. for avoiding overheating at least one of the object types in the cooking region.

In various embodiments, method 1000 includes at 1060 operating the cooking appliance based on the determined cooking program.

In some embodiments, method 1000 may include at 1070 determining a change at the one or more objects during a cooking cycle (e.g., operation based on method 1000 at 1060). Method 1000 at 1070 may include determining a heated state of one or more objects at the cooking region. For instance, method 1000 may determine whether one or more of the objects displays a heated state at (e.g., steaming, perspiring, etc.), an overcooked state (e.g., browning, burning, etc.), or an un-heated state (e.g., no change to the object). Method 1000 may determine whether the segmented pixels (e.g., via step 1040) or the detected objects (e.g., via step 1020) compares to an object in the heated state. Method 1000 at 1070 may include comparing one or more objects to a version of the type or class of object in the heated state, and determining (e.g., via pixel comparison, probability, etc.) whether the one or more objects exceeds a threshold probability of heated state.

Embodiments of the system 100 and method 1000 depicted and described herein overcome issues as may be related to predetermine cooking programs, quantity-based estimation models, object occlusion (e.g., obscuring of objects detectable by an imaging device), and limitations to object detection models. In various embodiments, the object detection model may be utilized to determine a food type at the cooking region. However, object occlusion may obscure quantities of the object from detection (e.g., via occlusion from other objects).

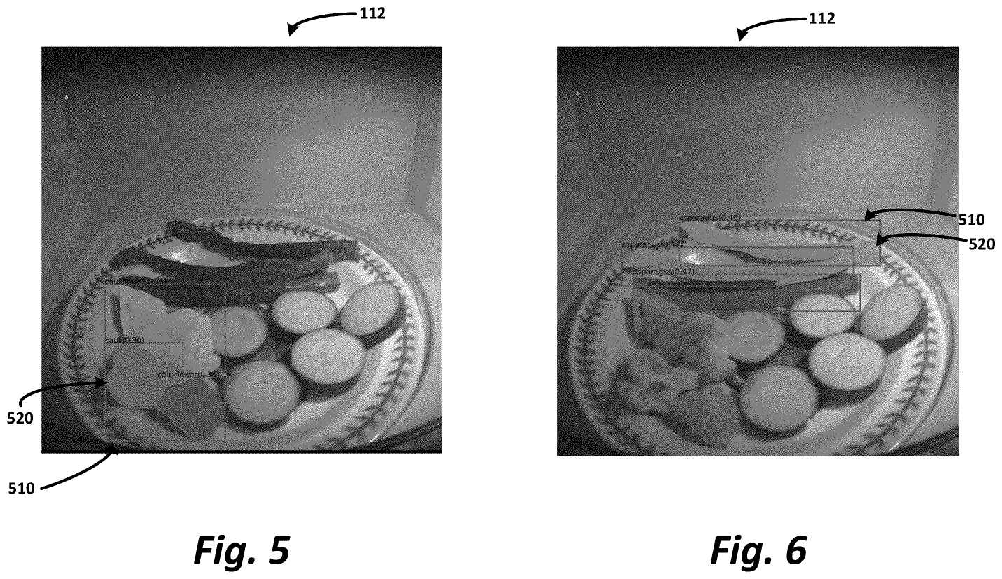

The object detection model generates a bounding box at the one or more objects (e.g., a rectangle), such as depicted at box 510 at FIGS. 5-6. However, the object detection model generally includes surrounding, non-germane pixels within the bounding box (e.g., a non-exact shape of the object). The segmentation model generates relatively tight-fit perimeters of the object, such as depicted at perimeter 520 at FIGS. 5-6. Comparing the quantity of segmentation pixels to a per-pixel weight map determines an estimated physical weight (e.g., in grams, ounces, etc.) of the object. The method may determine the cooking program, or adjustments thereto, based on weight of the object.

Estimation based on weight such as provided in embodiments of the method may provide advantages over estimation based on quantity or user-input weight. For instance, methods based on quantity may fail to address issues arising from object occlusion. In another instance, methods based on user-input quantity may fail to address differences in object type.

Additionally, or alternatively, estimations based on determining object weight from segmentation pixels may allow for greater tolerance or error range in contrast to other methods. For instance, estimations based on determining object weight from segmentation pixels may allow for differences of +/−2% or greater, or +/−5% or greater, or +/−10% or greater, or +/−25% or greater, without substantially altering the cooking program. Still further, embodiments provided herein may be utilized for determining a heated state, undercooked state, or overcooked state, such as to modify the cooking program (e.g., stop, extend, or un-changed) based on the determined objects and object types.

Embodiments of the first detection model may form an object detection model configured as a self-supervised learning model, such as a self-distillation where no labels are required, such as a DINO model. In still various embodiments, the object detection model is configured as a zero-shot object detection model combining a transformer-based DINO detector and grounded pre-training.

Embodiments of the second detection model may form a segmentation model configured to divide an image, or portion thereof (e.g., within the bounding box, such as described herein) into multiple segments or regions based on various properties. The segmentation model is configured to generate object masks, such as perimeters as described herein, from an input prompt, such as the bounding box described herein.

Referring back to FIG. 2, cooking appliance 110 includes controller 120 configured to regulate, allow, inhibit, articulate, or otherwise operate the cooking appliance 110 such as described herein (e.g., to command or discontinue a cooking program, to set or modify a cook time, a power output, etc.). Controller 120 may be positioned in a variety of locations throughout the cooking appliance 110. In some embodiments, input/output (“I/O”) signals are routed between controller 120 and various operational components of the cooking appliance 110 along wiring harnesses that may be routed (e.g., heating elements, power units, magnetrons, etc.). Controller 120 may include user interface panel 114 through which a user may select various operational features, operating modes, monitor progress, provide user inputs, or receive communication messages at the cooking appliance 110. The user interface 114 panel may represent a general purpose I/O (“GPIO”) device or functional block. Additionally, the user interface panel 114 may include input components, such as one or more of a variety of electrical, mechanical, or electro-mechanical input devices including rotary dials, push buttons, and touch pads. The user interface panel 114 may also include a display component, such as a digital or analog display device designed to provide operational feedback to a user. The user interface panel 114 may be in communication with the controller 120 via one or more signal lines or shared communication busses.

Controller 120 may include one or more processing devices 122 and memory devices 124. As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 120 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Memory device(s) 124 may include non-transitory computer-readable storage mediums, such as RAM, ROM, EEPROM, EPROM, flash memory devices, magnetic disks, or other suitable memory devices (including combinations thereof). These memory devices may be a separate component from the processing device 122 or may be included onboard within the processor. In addition, memory devices 124 can store information and/or data accessible by the one or more processors 122, including instructions 126 that can be executed by the one or more processors, such as one or more steps of method 1000. It should be appreciated that instructions 126 can be software written in any suitable programming language or can be implemented in hardware. Additionally, or alternatively, instructions 126 can be executed logically and/or virtually using separate threads on one or more processors 122. Executed instructions 126 cause the cooking appliance 110 to perform operations, such as one or more steps of method 1000.

Embodiments of the communications device 128 may be configured as any appropriate wired or wireless communications device, such as, but not limited to, Bluetooth®, Unison, Xender, Xigbee®, Wi-Fi, etc. The communications device 128 may be configured to communicatively couple to a remote or cloud-based server 150 or computing network 132. Network 132 may include one or more of a local area network (LAN), a wide area network (WAN), a personal area network (PAN), the Internet, a cellular network, or any other suitable wireless network. Communications device 128 is configured to transmit and receive, signals, data packets, information, datasets, and the like, over the network 132, or furthermore, with remote computing device or server 150. The server 150 may be configured to store and transmit data in a database, or providing computational processing, relating to controls, control signals, software patches or updates, or other processes as may be appropriate for the cooking appliance 110, such as described herein in regard to maps, tables, object detection models, segmentation models, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for cooking appliance operation, the method comprising:
obtaining an image at a cooking region;
determining, via a first detection model, a bounding of one or more types of objects within the image;
setting, at a second detection model, a region of interest at the image including the objects;
determining, via the second detection model, a quantity of segmented pixels for each type of object within the image;
determining a weight of each type of object based on the quantity of segmented pixels corresponding to each type of object within the image;
corresponding the weight of each type of object in the image to a cooking program; and
operating the cooking appliance based on the cooking program.

2. The method of claim 1, wherein the first detection model is an object detection model configured to determine a bounding of one or more types of objects within the image.

3. The method of claim 2, wherein the second detection model is a segmentation model configured to determine the quantity of segmented pixels corresponding to each type of object within the image.

4. The method of claim 1, wherein determining the bounding of one or more types of objects within the image comprises corresponding the image to a predetermined set of objects.

5. The method of claim 1, wherein corresponding the weight of each type of object comprises corresponding a total weight of each type of object in the image to a cooking program.

6. The method of claim 1, comprising:
obtaining an input signal corresponding to a type of object.

7. The method of claim 6, wherein obtaining the input signal corresponding to a type of object comprises transmitting the input signal corresponding to the determined type of object based on a predetermined set of objects.

8. The method of claim 1, comprising:
determining minimum and maximum ranges of cook parameter.

9. The method of claim 1, comprising:
determining a change at the one or more objects during a cooking cycle.

10. The method of claim 1, wherein determining the weight of each type of object based on the quantity of segmented pixels corresponding to each type of object within the image comprises comparing the quantity of segmented pixels to a per-pixel weight map.

11. A cooking appliance, comprising:
an imaging device configured to obtain an image at a cooking region of the cooking appliance;
a controller configured to store instructions that, when executed, causes the cooking appliance to perform operations, the operations comprising:
obtaining, via the imaging device, an image at the cooking region;
determining, via a first detection model, a bounding of one or more types of objects within the image;
setting, at a second detection model, a region of interest at the image including the objects;
determining, via the second detection model, a quantity of segmented pixels for each type of object within the image;
determining a weight of each type of object based on the quantity of segmented pixels corresponding to each type of object within the image;
corresponding the weight of each type of object in the image to a cooking program; and
operating the cooking appliance based on the cooking program.

12. The cooking appliance of claim 11, wherein the first detection model is an object detection model configured to determine a bounding of one or more types of objects within the image.

13. The cooking appliance of claim 12, wherein the second detection model is a segmentation model configured to determine the quantity of segmented pixels corresponding to each type of object within the image.

14. The cooking appliance of claim 11, wherein determining the bounding of one or more types of objects within the image comprises corresponding the image to a predetermined set of objects.

15. The cooking appliance of claim 11, wherein corresponding the weight of each type of object comprises corresponding a total weight of each type of object in the image to a cooking program.

16. The cooking appliance of claim 11, comprising:
obtaining an input signal corresponding to a type of object.

17. The cooking appliance of claim 16, wherein obtaining the input signal corresponding to a type of object comprises transmitting the input signal corresponding to the determined type of object based on a predetermined set of objects.

18. The cooking appliance of claim 11, comprising:
determining minimum and maximum ranges of cook parameter.

19. The cooking appliance of claim 11, wherein the cooking appliance is a microwave oven appliance, a conventional oven appliance, a convection oven appliance, or combinations thereof.

20. The cooking appliance of claim 11, wherein determining the weight of each type of object based on the quantity of segmented pixels corresponding to each type of object within the image comprises comparing the quantity of segmented pixels to a per-pixel weight map.
